(19) United States
(12) Patent Application Publication
(10) Pub. No.: US 2011/0145205 A1
(43) Pub. Date: Jun. 16, 2011

(54) Packet Boundary Spanning Pattern Matching Based At Least In Part Upon History Information

(76) Inventors: Sanjeev Jain, Chandler, AZ (US); Christopher F. Clark, Chandler, AZ (US); David K. Cassetti, Tempe, AZ (US)

(21) Appl. No.: 12/637,488

(22) Filed: Dec. 14, 2009

(51) Int. Cl. G06F 17/30; G06F 15/16; G06F 21/00

(52) U.S. Cl. 707/687; 709/224; 707/769; 726/24; 713/188; 707/E17.014; 707/E17.005

(57) ABSTRACT

An embodiment may include circuitry to determine, at least in part, based at least in part upon history information, whether one or more reference patterns are present in a data stream in a packet flow. The data stream may span at least one packet boundary in the packet flow. The history information may include a beginning portion of a packet in the data stream, an ending portion of the packet, and another portion of the data stream. The circuitry may overwrite the another portion of the history information with a respective portion of the data stream to be examined by the circuitry depending, at least in part, upon whether the circuitry determines, at least in part, whether the one or more reference patterns are present in the data stream. The respective portion may be relatively closer than the another portion is to a beginning of the data stream.

### FIELD

This disclosure relates to packet boundary spanning pattern matching based at least in part upon history information.

### BACKGROUND

In one type of conventional arrangement, a first host receives packets from a second host via a network. Software agents executed by, in association with, and/or as part of the operating system in the first host implement malicious program (e.g., virus) detection operations with respect to the received packets. Such detection operations involve comparison of received packet data with patterns indicative of malicious programs. Unfortunately, in this conventional arrangement, as a result of the agents being software processes that rely upon the operating system, the agents themselves and their operations may be relatively easily tampered with by the malicious programs. Also, if the agents are executed by the first host's host processor, an undesirably large amount of the host processor's processing bandwidth, as well as, an undesirably large amount of processing time may be consumed by these agents.

Additionally, in such conventional detection schemes, the comparison of the packet data with the patterns cannot be carried out concurrently with updating of patterns. Therefore, unfortunately, in such conventional detection schemes, if while the comparison of the data packet is underway, new patterns become available, the comparison of the packet data may be interrupted until after the updating of the patterns has been completed, in order to permit newest patterns to be used in the comparison. This may delay the completion of the comparison.

Also, in such conventional detection schemes, it is typically very difficult or impossible to meaningfully compare data from multiple packets (e.g., spanning one or more boundaries between or among the packets), as a combined single unit, to the patterns. This is disadvantageous since malicious programs exist that span multiple packets in such a way as to attempt to exploit this limitation of conventional detection schemes, and thereby, to avoid detection by such conventional detection schemes. Furthermore, if a pattern update takes place after the start, but prior to the completion of the comparison, in these conventional schemes, the partially completed comparison may be restarted from the beginning of the packet flow, using the updated patterns, in order to attempt to detect the presence of patterns that may span multiple packets in the flow. This may undesirably increase the amount of memory (e.g., to store the packets in the flow), as well as, the amount of processing bandwidth used in these conventional schemes.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates pattern matching circuitry in an embodiment.

FIG. 3 illustrates pattern matching circuitry in an embodiment.

FIG. 4 illustrates a portion of the circuitry of FIG. 3.

FIG. 5 illustrates operations in an embodiment.

FIG. 6 illustrates operations in an embodiment.

FIG. 7 illustrates operations in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

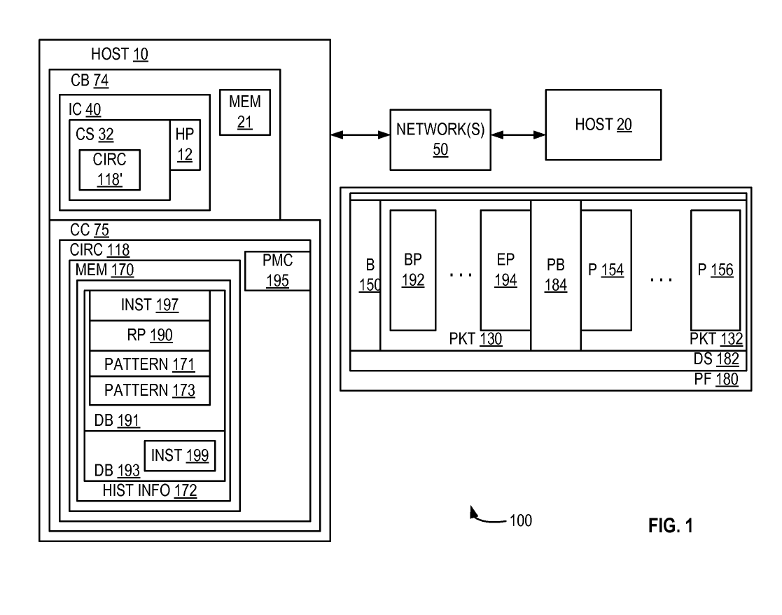

FIG. 1 illustrates a system embodiment 100. System 100 may include one or more hosts 10 communicatively coupled to one or more hosts 20 via one or more networks 50. In this embodiment, the term “host” may mean, for example, one or more end stations, appliances, intermediate stations, network interfaces, clients, servers, and/or portions thereof. Although one or more hosts 10, one or more hosts 20, and one or more networks 50 will be referred to hereinafter in the singular, it should be understood that each such respective component may comprise a plurality of such respective components without departing from this embodiment. In this embodiment, a “network” may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, data may be or comprise one or more commands (such as for example one or more program instructions), and/or one or more such commands may be or comprise data. Also in this embodiment, an “instruction” may include data and/or one or more commands.

Host 10 may comprise circuit board (CB) 74 and circuit card (CC) 75. In this embodiment, CB 74 may comprise, for example, a system motherboard and may be physically and communicatively coupled to CC 75 via a not shown bus connector/slot system. CB 74 may comprise one or more integrated circuits (IC) 40 and computer-readable/writable memory 21. In this embodiment, each of the one or more IC 40 may be embodied as, for example, one or more semiconductor modules, chips, and/or substrates. One or more IC 40 may comprise one or more host processors (HP) 12 and one or more chipsets (CS) 32. One or more HP 12 may be communicatively coupled via one or more CS 32 to memory 21 and CC 75.

Each of the one or more HP 12 may comprise, for example, a respective multi-core Intel® microprocessor. Of course, alternatively, each of the HP 12 may comprise a respective different type of microprocessor.

CC 75 may comprise circuitry 118. Circuitry 118 may comprise computer-readable/writable memory 170 and pattern matching circuitry (PMC) 195. Memory 170 may store one or more databases (DB) 191 and history information 172.

Alternatively, as shown in FIG. 1, some or all of circuitry 118 and/or the functionality and components thereof may be comprised in, for example, circuitry 118′ that may be comprised in whole or in part in one or more CS 32. Further alternatively, some or all of circuitry 118 and/or the functionality and components thereof may be comprised in one or more HP 12. Also alternatively, one or more HP 12, memory 21, one or more CS 32, one or more IC 40, and/or some or all of the functionality and/or components thereof may be comprised in, for example, circuitry 118 and/or CB 75. In another alternative arrangement, some or all of the functionality and/or components of one or more CS 32 may be comprised in one or more HP 12, or vice versa. Many other alternatives are possible without departing from this embodiment.

Although not shown in the Figures, host 20 may comprise, in whole or in part, the components and/or functionality of host 10. Alternatively, host 20 may comprise components and/or functionality other than and/or in addition to the components and/or functionality of host 10.

As used herein, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also, in this embodiment, a “host processor,” “processor,” “processor core,” “core,” and “co-processor,” each may comprise respective circuitry capable of performing, at least in part, one or more arithmetic and/or logical operations, such as, for example, one or more respective central processing units. Also in this embodiment, a “chipset” may comprise circuitry capable of communicatively coupling, at least in part, one or more HP, storage, mass storage, one or more hosts, and/or memory. Although not shown in the Figures, host 10 and/or host 20 each may comprise a respective graphical user interface system. Each such graphical user interface system may comprise, e.g., a respective keyboard, pointing device, and display system that may permit a human user to input commands to, and monitor the operation of, host 10, host 20, and/or system 100.

One or more machine-readable program instructions may be stored in computer-readable/writable memory 21 and/or circuitry 118. In operation of host 10, these instructions may be accessed and executed by one or more HP 12, circuitry 118, and/or PMC 195. When executed by one or more HP 12, circuitry 118, and/or PMC 195, these one or more instructions may result in one or more HP 12, circuitry 118, and/or PMC 195 performing the operations described herein as being performed by one or more HP 12, circuitry 118, and/or PMC 195. In this embodiment, “memory” may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory.

In this embodiment, host 10 and host 20 may be geographically remote from each other. Circuitry 118 and/or one or more CS 32 may be capable of exchanging data and/or commands with host 20 via network 50 in accordance with one or more protocols. These one or more protocols may be compatible with, e.g., an Ethernet protocol and/or Transmission Control Protocol/Internet Protocol (TCP/IP).

The Ethernet protocol that may be utilized in system 100 may comply or be compatible with the protocol described in Institute of Electrical and Electronics Engineers, Inc. (IEEE) Std. 802.3, 2000 Edition, published on Oct. 20, 2000. The TCP/IP that may be utilized in system 100 may comply or be compatible with the protocols described in Internet Engineering Task Force (IETF) Request For Comments (RFC) 791 and 793, published September 1981. Of course, many different, additional, and/or other protocols may be used for such data and/or command exchange without departing from this embodiment, including for example, later-developed versions of the aforesaid and/or other protocols.

In this embodiment, host 20 may transmit to host 10 via network 50 one or more packet flows (PF) 180. One or more PF 180 may comprise one or more data streams (DS) 182. One or more DS 182 may comprises a plurality of packets, including, as shown in FIG. 1, one or more packets 130 and one or more packets 132. In this embodiment, one or more packets 130 and one or more packets 132 may be separated and/or delimited from each other by one or more packet boundaries (PB) 184. One or more packets 130 may comprise a beginning portion (BP) 192 and an ending portion (EP) 194. One or more packets 132 may comprise one or more portions 154 and one or more portions 156. DS 182 may comprise a beginning 150. In this embodiment, the relative order of each of these portions of the packets 130, 132 may be as illustrated in FIG. 1. Thus, for example, BP 192 may be relatively closer to the beginning 150 of DS 182 than EP 194 may be, but EP 194 may be relatively closer to the beginning 150 of DS 182 than one or more portions 154 may be. Also, one or more portions 154 may relatively closer to the beginning 150 than one or more portions 156 may be. In operation of system 100, circuitry 118 may receive one or more PF 180 from network 50.

In this embodiment, a packet may comprise one or more symbols and/or values. Also in this embodiment, a fragment of a packet and a packet may be used interchangeably and may comprise some or all of a packet and/or one or more contiguous or non-contiguous portions of a packet. Furthermore, in this embodiment, a packet boundary may separate, delimit, and/or define, at least in part, one or more packets from one or more other packets, and/or one or more fragments of packets from one or more fragments of packets. In this embodiment, a “portion” of an entity may comprise some or all of that entity.

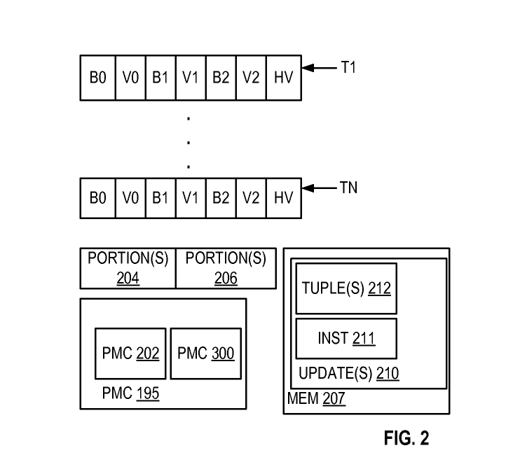

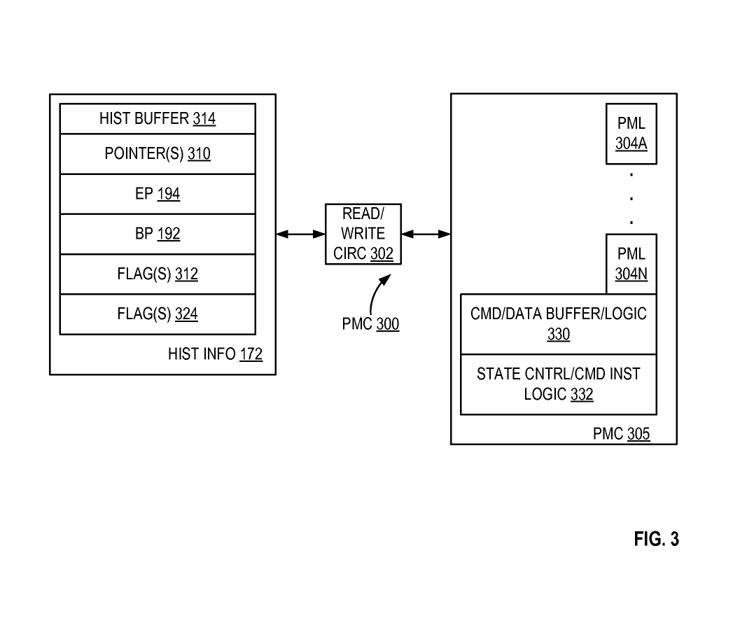

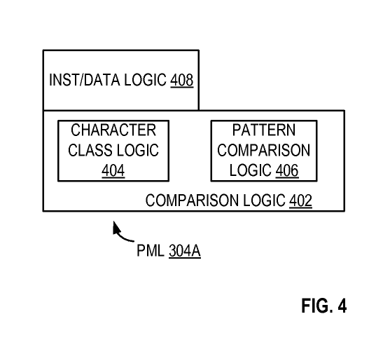

As shown in FIG. 2, in this embodiment, PMC 195 may comprise PMC 202 and PMC 300. PMC 300 may comprise pattern matching logic (PML) circuitry 305 and read/write circuitry 302 (see FIG. 3). PML circuitry 305 may comprise multithreaded PML units 304A . . . 304N, command/data buffers and first-in-first-out (FIFO) logic 330, and state control/command instruction logic 332. As shown in FIG. 4, PML unit 304A may comprise instruction and data logic 408 and pattern comparison logic 402. Comparison logic 402 may comprise character class comparison logic 404 and pattern comparison logic 406. The construction and operation of each of the other PML units (e.g., PML unit 304N) may be similar or identical to the construction and operation of. PML unit 304A. It should be appreciated that the construction and operation of system 100 (and the components thereof) may differ (e.g., by having more or fewer components, functions and/or operations from that which is illustrated and/or described herein) in whole or in part from that which is set forth herein, without departing from this embodiment.

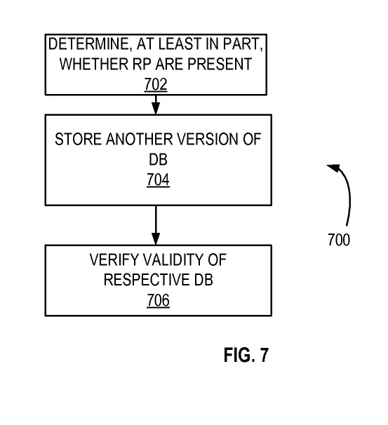

With particular reference now being made to FIG. 7, operations 700 that may be performed in system 100 will be described. After or contemporaneously with receipt, at least in part, of one or more flows 180, circuitry 118 may determine, at least in part, based at least in part upon history information 172, whether one or more reference patterns (RP) are present in one or more DS 182, as illustrated by operation 702. In this embodiment, this determination, at least in part, by circuitry 118 may be carried out, at least in part, by PMC 202 and 300 (see FIG. 2). In this embodiment, a pattern may comprise one or more contiguous or non-contiguous symbols and/or values. Also in this embodiment, one or more RP 190 may embody, comprise, and/or be indicative and/or characteristic of, at least in part, one or more malicious, unauthorized, and/or undesired instructions and/or data (e.g., virus code and/or data). Therefore, the presence of one or more RP 190 in one or more DS 182 may indicate, at least in part, that one or more such instructions and/or data are present, at least in part, in one or more DS 182.

PMC 202 may be coupled to PMC 300. PMC 202 may determine, based at least in part upon one or more hashing operations and one or more predetermined pattern matching operations whether one or more portions 204 of one or more RP 190 are present in one or more DS 182. If PMC 202 determines that one or more portions 204 are present in one or more DS 182, PMC 300 may determine, based at least in part upon one or more multithreaded pattern matching operations, whether one or more other portions 206 of these one more RP 190 are present in the one or more DS 182. In this embodiment, the one or more hashing and predetermined pattern matching operations carried out by PMC 202 may be based, at least in part, upon respective tuples T1 . . . TN. Each of these tuples T1 . . . TN may comprise respective predetermined possible data stream patterns (e.g., byte patterns B0, B1, and B2) and respective hash values (HV). These tuples T1 . . . TN may be stored, at least in part, in DB 191 in memory 170. DB 191 also may comprise one or more RP 190, one or more patterns 171, one or more patterns 173, and/or one or more instructions 197.

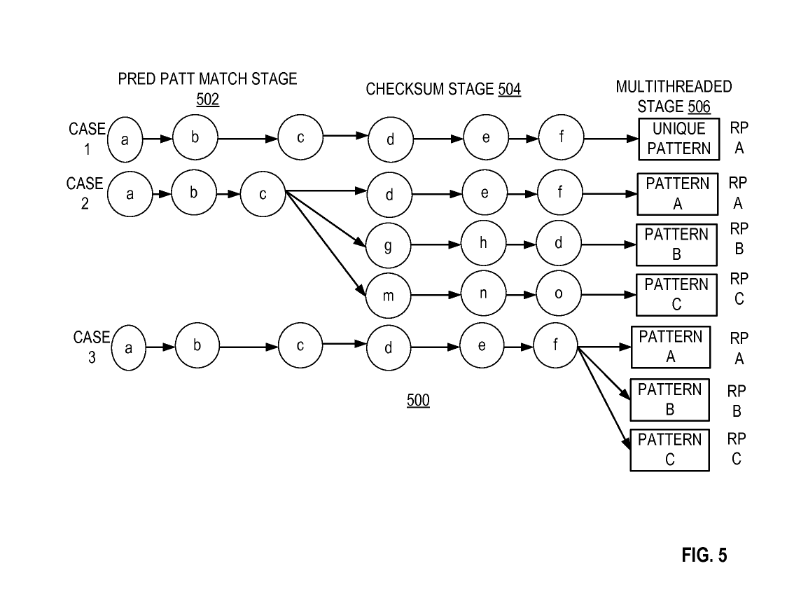

For reasons described later in connection with FIG. 5, another memory 207 (e.g., that may be comprised in circuitry 118) may store, in and/or as one or more updates 210 to the DB 191, one or more additional tuples 212. PMC 202 may access memories 170 and/or 207 to access the tuples T1 . . . TN and/or 212. The respective byte patterns and checksum hash values stored in the respective tuples may be indicative and/or characteristic of the presence of respective portions of respective RP 190. For example, the presence of byte patterns B0, B1, and B2 of T1 in one or more DS 182, together with a match of one or more HV of that tuple T1 with one or more hash values generated based upon one or more adjacent portions of the DS 182 (e.g., adjacent to the matching byte patterns in DS 182) may indicate and/or be characteristic of the presence of one or more portions 204 of one or more RP 190 in one or more DS 182.

PMC 202 may comprise a relatively faster comparison path for purposes of pattern matching relative to the comparison path embodied by PMC 300. This may result from PMC 202 comprising relatively faster, but less detailed and/or programmatically powerful, set-wise and/or fixed string pattern matching circuitry, as compared to PMC 300. PMC 300, on the other hand, may comprise relatively slower, multithreaded very large instruction word PML circuitry 305 that may be capable of performing relatively more detailed and programmatically powerful deterministic regular expression pattern matching operations than PMC 202 is capable of performing. PMC 202 may compare, for example, byte patterns (e.g., B0, B1, and/or B3) in a respective tuple (e.g., T1) to the incoming respective bytes received in DS 182 to determine whether these byte patterns exactly match respective byte patterns in DS 182. If PMC 202 determines that such an exact match is present in DS 182, PMC 202 may perform one or more checksum hashing operations on one or more subsequently input portions of the DS 182 (e.g., following and/or adjacent to the exactly matching byte patterns in DS 182) to generate one or more checksum hash values. PMC 202 may compare these one or more hash values to one or more hash values HV in T1. If a match exists, PMC 202 may determine that one or more portions 204 of one or more RP 190 may be present in one or more DS 182, and PMC 202 may indicate this to PMC 300. Of course, without departing from this embodiment, one or more values HV may alternatively or additionally specify one or more addresses in memory 170 and/or 21 in which the associated checksum hash values to be used in such comparison may be stored. Also without departing from this embodiment, the information contained in tuples T1 . . . TN may be stored and/or may available in other formats and/or via other techniques.

In response, at least in part, to this indication from PMC 202, PMC 300 may determine, based at least in part upon history information 172, whether one or more portions 206 of one or more RP 190 may be present in one or more DS 182. If PMC 300 determines that one or more such portions 206 are present in one or more DS 182, circuitry 118 may indicate to the one or more (not shown) application processes executed by HP 12 that one or more RP 190 have been found and/or are present in one or more DS 182. These one or more application processes then may take appropriate action to address the presence of the one or more RP 190 in one or more DS 182.

As shown in FIG. 3, history information 172 may comprise circular history buffer 314, one or more beginning of line, end of line, and/or carriage return pointers 310, EP 194, BP 192, one or more flags 312, and/or one or more flags 324. One or more flags 312 may indicate whether one or more patterns 171 are present in one or more DS 182. One or more flags 324 may indicate whether one or more patterns 173 have been found by circuitry 118 in one or more DS 182. In this embodiment, a beginning of line character and/or end of line character may delimit and/or embody a boundary between lines.

One or more patterns 171 may be or comprise one or more “floating” patterns whose presence anywhere within the one or more DS 182 and/or one or more packets 130, 132 may be indicative of the presence of one or more RP 190 (or one or more portions thereof) in one or more DS 182, if one or other portions (e.g., one or more portions 206) are also present in one or more DS 182, regardless of the relative displacement between the one or more portions 206 and the one or more floating patterns. After circuitry 202 or 300 determines that one or more such floating patterns are present in one or more DS 182, one or more associated flags in one or more flags 312 may be set to indicate the presence of such floating patterns.

One or more patterns 173 may be or comprise one or more “disabled” patterns whose presence, even if only in the form a single instance in the one or more DS 182 (and regardless of the number of any repeated instances), may be indicative, at least in part, of the one or more RP 190 or one or more portions thereof. After circuitry 300 determines that one or more such disabled patterns are present in one or more DS 182, one or more associated flags in one or more flags 324 may be set to indicate the presence of such disabled patterns in one or more DS 182. Thereafter, circuitry 118 may no longer track any additional instances of the one or more disabled patterns associated with the one or more set flags in one or more flags 324.

In this embodiment, if a respective RP 190 involves one or more particular floating patterns, circuitry 118 first may determine whether every part of the respective RP 190 is present in the one or more DS 182, and every other part of the respective RP 190 is present in the one or more DS 182 except for the one or more particular floating patterns, circuitry 118 may examine the one or more flags 312 to determine whether the one or more particular floating patterns previously have been found in the one or more DS 182. If such is the case, circuitry 118 may indicate, e.g., to the one or more application processes (not shown) executed by HP 12, that the respective RP 190 has been found in the one or more DS 182. Conversely, if the one or more flags 312 do not indicate that the one or more particular floating patterns have been found, but every other portion of the respective RP 190 has been found in one or more DS 182, circuitry 118 may again review the one or more flags 312 after PMC 202 has processed the end of the current packet in one or more DS 182 that is undergoing examination by PMC 202. If, at the time of this review, the one or more flags 312 indicate that the one or more particular floating patterns have been found, circuitry 118 may indicate to the one or more application processes that the respective RP 190 has been found in the one or more DS 182. Conversely, if at the time of this review, the one or more flags do not indicate that the one or more particular floating patterns have been found, circuitry 118 may repeat the above review process until the end of the DS 182 has undergone examination by PMC 202.

In this embodiment, one or more of the above components of history information 172 may be respectively replicated for each of the flows comprised in one or more flows 180, such that each respective flow may be associated with respective history information having one or more respective corresponding components from the respective flow. History information 172 may also comprise other and/or additional components (e.g., one or more currently active commands/reference patterns pending execution/comparison by circuitry 118), without departing from this embodiment.

In this embodiment, circuitry 118 may maintain in memory 170 one or more data structures (not shown) that are logically linked, at least in part, to the one or more flags 312 and may indicate, at least in part, which patterns (e.g., portions 204 and/or 206) circuitry 118 may have found to be present in one or more DS 182. For example, depending upon the particular parameters and numbers of the one or more RP 190, one or more floating patterns, and/or one or more disabled patterns, etc., the presence of these one or more patterns in one or more DS 182 may be indicated, at least in part, in a data structure (not shown) comprising a plurality of blocks. A beginning field (not shown) in the not shown structure may indicate the total number of valid blocks comprised in the structure. Following the beginning field may be a number of blocks (not shown). Each such block may include a respective block offset address, a respective bit vector, and one or more respective detected patterns. The respective block offset address may point to a respective structure (not shown) in external memory (e.g., memory 21) to store one or more one or more detected patterns (e.g., one or more portions 204 and/or 206) of the one or more RP 190. The respective bit vector may indicate the number of bytes following the respective block offset address that are valid. Circuitry 118 also may store in memory 170 one or more other similar data structures and/or blocks that may be logically linked, at least in part, to one or more flags 324. Of course, many alternatives, variations, and alternatives are possible without departing from this embodiment. Advantageously; by employing these one or more data structures in memory 170, a relatively small amount of memory (e.g., on-chip memory if circuitry 118 is embodied, at least in part, as an integrated circuit chip, die, or substrate) 170 may be occupied to maintain relatively quick access by circuitry 118 to pattern detection state information, while still permitting such information to be coherently merged with and/or extracted from an external store of such information (e.g., in memory 21).

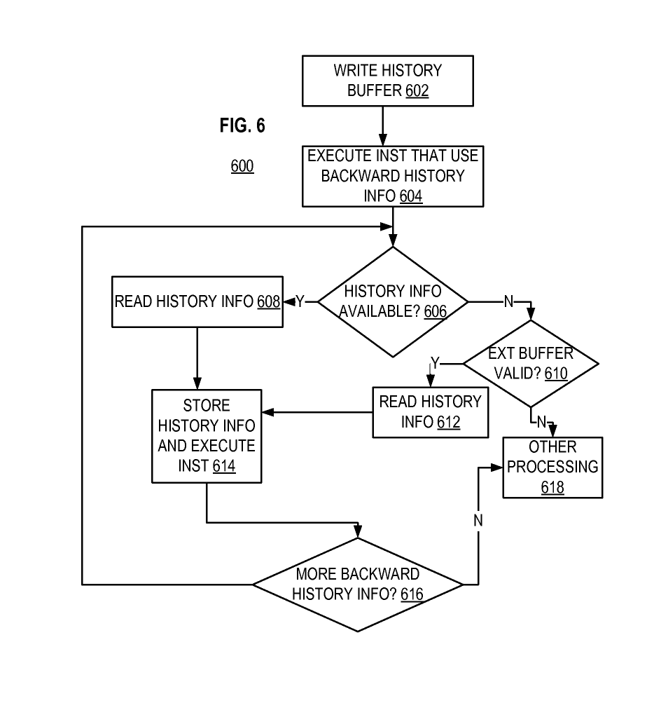

As part of operation 702, operations 600 (see FIG. 6) may be carried out, at least in part, by circuitry 118. As stated previously, in this embodiment, circuitry 118 (and memory 170) may be embodied, at least in part, in an integrated circuit chip, substrate, and/or die. If a portion (e.g., portion 156) of one or more DS 182 is to be examined by PMC 300 (e.g., PML 304A), circuitry 118 and/or read/write circuitry 302 (either alone or in conjunction with one or more CS 32) may load into circular history buffer 314 a segment (e.g., in this embodiment, up to 6 kilobytes) of one or more DS 182 that includes the portion 156 to be examined, and also may store the portion 156 in command/data buffers/logic 332, as illustrated by operation 602. Thereafter, depending at least in part upon whether PML 304A, state control/command instruction logic 332, and/or PMC 300 determine, at least in part, based at least in part upon the examination of portion 156, whether one or more RP 190 are present in the one or more DS 182, PML 304A may execute one or more instructions that involve use of “backward” history information (see operation 604). For example, if, based at least in part upon the examination, it is determined at least in part that the one or more RP 190 have not yet been found in the one or more DS 182, the execution of the one or more instructions may implicate examination, in order to attempt to find the one or more RP 190, of such backward history information.

In this embodiment, “backward” history information means history information (e.g., in this embodiment, comprising portion 154, EP 194, and/or BP 192) from the one or more DS 182 that is relatively closer to the beginning 150 of the one or more DS 182 than is the portion (e.g., portion 156) of one or more DS 182 that is or was most recently being examined by PMC 300 and/or circuitry 118. Also in this embodiment, “history information” means one or more symbols and/or values derived, at least in part, and/or obtained, at least in part, from one or more packet flows (such as, e.g., one or more PF 180).

The execution of these one or more instructions may result, at least in part, in read/write circuitry 302 and/or circuitry 118 determining whether the implicated backward history information (e.g., comprising portion 154) currently is available on-chip (e.g., from the on-chip portion of history buffer 314 and/or memory 170), as illustrated by operation 606. If the backward history information currently is available on-chip, read/write circuitry 302 and/or PMC 300 may read such information from the on-chip portion of history buffer 314 and/or memory 170 (see operation 608) and may store portion 154 from such backward history information in logic 330 (see operation 614).

Conversely, if such backward history information currently is not available on-chip, read/write circuitry 302, PMC 300, and/or circuitry 118 may validate whether the external (e.g., off-chip) portion of history buffer 314 contains valid data, as illustrated by operation 610. If that portion of history buffer 314 does not contain valid data that comprises the backward history information, circuitry 118 and/or PMC 300 may proceed with other processing (see operation 618). In this case, such other processing may comprise termination of the currently executing thread in PML 304A, perhaps to be re-executed at a later time (e.g., when the history buffer 314 may contain valid data comprising such backward history information). Conversely, if the off-chip portion of the history buffer 314 does contain valid data that comprises the backward history information, read/write circuitry 302, PMC 300, and/or circuitry 118 may read such information from the off-chip portion of history buffer 314 and/or memory 170 (see operation 612), may store such backward history information in the on-chip portion of history buffer 314, and may store portion 154 in logic 330 (see operation 614).

After operation 614 has been performed, PML 304A, state control/command instruction logic 332, and/or PMC 300 may determine, at least in part, based at least in part upon the examination of portion 154, whether the execution of the one or more additional instructions (e.g., by PML 304A) may implicate examination, in order to attempt to find the one or more RP 190, of additional backward history information (see operation 616). If so, operations 600 may branch back to continue with performance of operation 606. Otherwise, circuitry 118 and/or PMC 300 may proceed with other processing (see operation 618). In this case, such other processing may comprise examination and/or storing of forward history information, termination of the currently executing thread in PML 304A, and/or other processing.

In this embodiment, EP 194 may comprise the final 32 bytes of data from one or more packets and/or packet fragments stored in history buffer 314 and/or currently undergoing examination by circuitry 118. BP 192 may comprise the beginning 64 bytes of payload from these one or more packets and/or packet fragments. One or more pointers 310 may comprise pointers to the final 16 beginning of line, end of line, and/or carriage return characters from these one or more packets and/or packet fragments. EP 194, one or more pointers 310, and/or BP 192 may be stored on-chip. Advantageously, this may permit the data stored therein to be readily available to PMC 202 and/or 300, for example, for purposes of, in the case of EP 194, (1) pattern examination and/or hash value calculations involving data adjacent to and/or spanning one or more packet boundaries (e.g., PB 184), and (2) reducing the amount of memory used to storing information related to hash value and/or pattern matching associated with data in EP 194. Also advantageously, in the case of BP 192 and one or more pointers 310, this may permit the data stored therein to be readily available to PMC 202 and/or 300, for example, for purposes of hash value and/or pattern matching (e.g., anchored pattern matching) involving such data (which, as is known to those skilled in the art, is often relevant to discovery of malicious data and/or instructions that may be present in one or more DS 182). Advantageously, these features of this embodiment may increase the case and speed with which such hash value and/or pattern matching (and therefore, also such discovery) may be accomplished. Further advantageously, in this embodiment, one or more flags 312 and/or 324 permit PMC 300 to be able to determine, without PMC 300 expending significant processing time and bandwidth, whether one or more floating patterns 171 and/or disabled patterns 173 have previously been found in one or more DS 182, and thereby, may further reduce the amount of time and processing bandwidth that otherwise might be expended by PMC 300, for example, in connection with again discovering such patterns 171, 173.

After storing (at least in part) DB 191 in memory 170 (which may happen, for example, after or contemporaneously with compilation of DB 191), it may be desired to update tuples T1 . . . TN and to include additional instructions in order to permit PMC 202 and PMC 300, respectively, to search for one or more additional portions of one or more additional RP. This may result, at least in part, from, for example, detection of additional virus threats. In order to allow this to occur, one or more firmware processes (not shown) executed by circuitry 118 may initiate the storing in memory 207, as one or more updates 210 to DB 191, one or more additional tuples 212 and one or more additional instructions 211.

Each of these additional tuples 212 may have respective contents that are similar or identical to the respective contents of respective tuples T1 . . . TN. However, the respective contents of tuples T1 . . . TN and/or additional tuples 212 may differ from each other and/or from that described herein, without departing from this embodiment. Although not described previously, as shown in FIG. 2, each tuple T1 . . . TN may comprise respective “valid” bits V0, V1, V2 that may be associated with the respective byte patterns B0, B1, B2 in each respective tuple. If set, a respective valid bit may indicate that the respective byte pattern with which it is associated is active (i.e., to be compared against the incoming bytes of the one or more DS 182 in the manner described previously) or inactive (i.e., not to be compared against the incoming bytes of the one or more DS 182). Thus, for example, if V0 is set in tuple T1, this indicates that PMC 202 is to compare the respective byte pattern with which it is associated (i.e., byte pattern B0) in tuple T1 against the incoming bytes of the one or more DS 182 in the manner described previously. Conversely, if V1 is not set in tuple T1, this indicates that PMC 202 is not to compare the respective byte pattern with which it is associated (i.e., byte pattern B1) in tuple T1 against the incoming bytes of the one or more DS 182 in the manner described previously. If a respective valid bit is not set, this effectively makes this byte pattern a wildcard. For example, in tuple T1, if V0 and V2 are set, but V1 is not set, then PMC 202 may compare (in the manner described previously) every three respective contiguously received incoming bytes from one or more DS 182 to the three byte pattern B0 X B2, where X may comprise any byte value. Thus, in this example, one or more portions 204 may comprise the three byte pattern B0 X B2.

In this embodiment, the maximum number of tuples that may be comprised in one or more tuples 212 may be 16. Also in this embodiment, the respective one or more HV comprised in each respective tuple may be generated based, at least in part, upon up to 32 incoming bytes from one or more DS 182. The specific respective number of bytes of one or more DS 182 that are to be used to generate the respective one or more HV may be specified by, for example, another respective value (not shown) that may be comprised in the respective tuple. Additionally, although not shown in the Figures, PMC 202 may comprise multiple replicated circuitry to perform in parallel multiple pattern matching and hashing operations. Of course, the maximum number of tuples 212, number of bytes used to generate the one or more HV, and/or the type and configuration of PMC 202 and 300 may vary without departing from this embodiment.

As stated previously, one or more updates 210 may comprise one or more updated instructions 211. These updated instructions 211 may be associated with the updated tuples 212 such that, if PMC 202 indicates to PMC 300 that a match exists in one or more DS 182 for one or more portions 204, and that match was determined to exist as a result of a respective tuple in one or more updated tuples 212 (e.g., one or more portions 204 are from an additional updated RP), PMC 300 may execute one or more respective updated instructions 211 associated with that respective tuple. This may result in PMC 300 determining, based at least in part upon history information 172, in the manner described previously, whether one or more portions 206 from that additional RP may be present in one or more DS 182.

In this embodiment, although not shown in the Figures, one or more portions of memory 207 may be comprised at least in part in, for example, PMC 202 and/or PMC 300. Alternatively, memory 207 may be comprised at least in part in memory 170 and/or elsewhere in circuitry 118. Also in this embodiment, the one or more not shown firmware processes may initiate the deleting of one or more tuples 212 and/or one or more instructions 211.

After the maximum number of tuples 212 has been stored in memory 207, it may be desired to add yet more additional tuples and instructions in order to permit PMC 202 and PMC 300, respectively, to search for one or more yet additional portions of one or more additional RP. In this embodiment, this may be accomplished by compiling a new DB 193 that includes all of the desired tuples and instructions (as well as, the other elements of DB 191, but including any desired modifications thereto). As such, the newly compiled DB 193 may be another (i.e., updated) version of DB 191. Circuitry 118 may store DB 193 in memory 170 while also maintaining the storage of DB 191 in memory 170, as illustrated by operation 704 in FIG. 7. That is, DB 193 may be stored in a set of memory locations in memory 170 that is a wholly disjoint from the memory locations in which DB 191 is stored, so as to avoid any portion of DB 191 being overwritten by any portion of DB 193. As a result, DB 191 and DB 193 may be both contemporaneously present in memory 170. Depending upon the particular parameters and configuration of circuitry 118, the maximum number of different DB versions that may be contemporaneously present may vary, but in this embodiment, there may be up to four such versions contemporaneously present in memory 170.

Circuitry 118 may assign to each respective DB 191, 193 different respective version identification numbers, and may indicate to PMC 300 which of respective version identification numbers is associated with a valid respective DB (i.e., a DB whose one or more instructions may be validly executed). Each of the respective instructions 197, 199 comprised in the respective DB 191, 193 may comprise, indicate, reference, and/or be associated with the respective version identification numbers of the respective DB that comprises that respective instruction. Prior to executing one of these instructions (regardless of whether the command originates from on-chip memory or off-chip memory) and/or fetching one of these instructions from off-chip memory, PMC 300 may verify whether the respective DB that contains the instruction is valid, as illustrated by operation 706 in FIG. 7. If the instruction is not from a valid DB, PMC 300 may discard (e.g., drop without executing) the instruction, or not fetch the instruction, and may provide indication of such action to the one or more not shown application processes.

After DB 193 has been stored in memory 170, PMC 202 may discard the results of any pending pattern matching and/or checksum hashing operations, and may restart such operations at an earlier point in the one or more DS 182 (e.g., in this embodiment, 32 bytes closer to the beginning of the one or more DS 182), using tuples from the new DB 193 instead of from DB 191. If PMC 202 previously indicated to PMC 300 that PMC 202 had found one or more matches (e.g., for one or more portions 204) subsequent to the point in one or more DS 182 at which PMC 202 restarted its operations, these results are not discarded, but PMC 202 may not again provide (i.e., for a second time) such indication to PMC 300. Advantageously, this may permit previous determinations of fully detected patterns not to be discarded, while also allowing processing by the PMC 300 to continue uninterrupted, despite change in operation of the PMC 202. Advantageously, this may enhance the ability of PMC 195 to be able to detect patterns spanning multiple packets, without substantial interruption, despite the DB updating.

Circuitry 118 may store respective base and/or other memory addresses of the respective DB. When circuitry 118 invalidates a DB, circuitry 118 may indicate that this DB is available to be overwritten and/or deleted in memory 170 by discarding its respective base and/or other memory addresses that circuitry 118 previously stored. The invalidation by circuitry 118 of a DB may occur at or after the time (hereinafter termed an “idle time”) when PMC 202 is ready to begin examination of a different packet from the packet that PMC 202 was examining when the new DB 193 was stored in memory 170.

Thus, in this embodiment, updated tuples and/or instructions may be stored in memory 207 and used by PMC 195. Additionally, until DB 191 is invalidated, the instructions in both DB 191 and the newly compiled DB 193 may be available for execution by PMC 300. Advantageously, in this embodiment, this may permit examination by PMC 195 of the packet data in one or more DS 182 to take place concurrently with the updating of the DB instructions and information (e.g., tuples) upon which such examination may be based. Thus, advantageously, in this embodiment, if while the comparison of the data packet is underway, new RP become available, the comparison of the packet data may continue substantially uninterrupted, while the DB update is underway.

After the initial storing of DB 191 in memory 170, it may be desired to no longer search for one or more specific RP in the one or more DS 182. If this is the case, and the one or more tuples and one or more instructions associated with one or more specific RP are stored in one or more updates 210 in memory 207, these one or more tuples and one or more one instructions may be deleted by circuitry 118 from the one or more updates 210. Conversely, if these one or more tuples and one or more instructions are not stored in the one or more updates 210, but instead are stored in the DB 191, different processes may be employed, depending at least in part upon whether the one or more specific RP may be uniquely determined to exist in the one or more DS 182 as a result of (1) one or more predetermined pattern matching operations of PMC 202, (2) one or more hashing operations of PMC 202, and/or (3) one or more multithreaded pattern matching operations of PMC 300.

For example, FIG. 5 illustrates operations 500 according to three different cases (i.e., Case 1, Case 2, and Case 3) in this embodiment. In Case 1, the one or more specific RP (“RP A”) may be uniquely determined to be present in one or more DS 182 based upon any of the above three processing stages. That is, RP A comprises three unique patterns (symbolically illustrated in FIG. 5 as “a b c”, “d e f”, and “unique pattern”), and the detection of any of these three patterns (e.g., in the predetermined pattern match stage 502 implemented by the PMC 202, the checksum stage 504 implemented by the PMC 202, or the multithreaded operation stage 506 implemented by PMC 300, respectively) may indicate the presence of the one or more specific RP in one or more DS 182. In Case 1, circuitry 118 may delete, e.g., during an idle time, the one or more tuples in DB 191 associated with the one or more specific RP, and may replace the one or more instructions associated with the one or more specific RP with one or more instructions that PMC 300 terminate pattern matching operations associated with the one or more specific RP without indicating to the one or more application processes that a match exists.

Conversely, in Case 2, the pattern “a b c” that may be found during the predetermined pattern match stage 508 may be common to multiple RP (i.e., “RP A,” “RP B,” and “RP C”), but the one or more specific RP (RP A) may be distinguished from the multiple RP in either the checksum stage 504 (i.e., by detecting which of the three unique patterns “d c f”, “g h d”, or “m n o”, respectively, are present in one or more DS 182) or the multithread operation stage 506 (i.e., by detecting which of the three unique patterns “Pattern A,” Pattern B,” or “Pattern C,” respectively are present in the one or more DS 182). In Case 2, circuitry 118 may delete, e.g., during an idle time, the one or more tuples in DB 191 containing one more HV associated with pattern “d c f” and/or RP A, and may replace the one or more instructions associated with Pattern A and/or RP A with one or more instructions that PMC 300 terminate pattern matching operations associated with Pattern A and/or RP A without indicating to the one or more application processes that a match exists.

Further conversely, in Case 3, the pattern “a b c” that may be found during the predetermined pattern match stage 502 and the pattern “d e f” that may be found during the checksum stage 504 may be common to multiple RP (i.e., “RP A,” “RP B,” and “RP C”), but the one or more specific RP (RP A) may be distinguished from the multiple RP in the multithreaded operation stage 506 (i.e., by detecting which of the three unique patterns “Pattern A,” Pattern B,” or “Pattern C,” respectively are present in the one or more DS 182). In Case 3, circuitry 118 may replace the one or more instructions associated with Pattern A and/or RP A with one or more instructions that PMC 300 terminate pattern matching operations associated with Pattern A and/or RP A without indicating to the one or more application processes that a match exists.

Turning now to FIG. 4, construction and operation of PML 304A in this embodiment will be described. PML 304 may be a special purpose multithreaded processor that may comprise specialized hardware capable of executing specialized instructions for implementing advantageous regular expression searches in one or more DS 182. For example, PML 304A may comprise instruction/data logic 408 and comparison logic 402. Logic 408 may be capable of loading and storing data (e.g., packet data from one or more DS 182 that may be stored, at least in part, in memory 170 and/or 21), and executing one or more instructions (e.g., one or more instructions 197) that may facilitate and/or implement examination by PML 304A of the one or more DS 182 for one or more portions 206 of one or more RP 190. This may permit PML 304A to determine, at least in part, in the manner described previously, whether one or more RP 190 are present in one or more DS 182. Although not shown in the Figures, logic 408 may comprise, for example, logic to fetch, load, and execute one or more instructions 197, logic to read data from and write data to memory 170 and/or 21, logic to track, save, and restore internal thread execution, context, logic, and/or data states (e.g., in connection with switching between or among examinations of flows in one or more PF 180), etc. Logic 408 also may be capable of coordinating and/or arbitrating (together with logic 330 and/or logic 332 in FIG. 3) the operations, states, and data manipulation of PML 304A with the respective operations, states, and data manipulations of the other PML, other logic comprised in PML circuitry 305, PMC 300, and/or circuitry 118.

Comparison logic 402 may be capable of various arithmetic, logical, and character and string search/comparison operations that are particularly powerful, useful, and advantageous. For example, logic 402 may comprise character class logic 404 and pattern comparison logic 406. Character class logic 404 may be capable of determining, at least in part, whether one or more particular classes (in contradistinction to specific discrete patterns or strings) of characters may be present in one or more DS 182. The particular classes of characters that may be searched for by logic 404 may be specified by one or more instructions (e.g., comprised in one or more instructions 197), and may include, for example, upper case, lower case, alphanumeric, non-alphanumeric, control, and/or other character classes. Logic 404 also may be capable of determining, at least in part, whether one or more such classes of characters are repeated and/or repeated a predetermined number of times in one or more DS 182. The particular parameters, including the number of repetitions to search for, may be specified by one or more instructions (e.g., comprised in one or more instructions 197). Pattern comparison logic 406 may be capable of determining, at least in part, whether one or more predetermined discrete byte/bit patterns may be present in one or more DS 182. Pattern comparison logic 406 also may be capable of determining, at least in part, whether one or more such predetermined discrete byte/bit patterns are repeated and/or repeated a predetermined number of times in one or more DS 182. The particular parameters, including the discrete byte/bit patterns, and the number of repetitions to search for, may be specified by one or more instructions (e.g., comprised in one or more instructions 197). Thus, in this embodiment, PML 304A and/or PMC 300 may determine, at least in part, whether one or more RP 190 are present in the one or more DS 182, based at least in part upon whether (1) one or more such character classes are present in the one or more DS 182, (2) the one or more classes of characters are repeated a predetermined number of times in the one or more DS 182, and/or (3) one or more predetermined byte/bit patterns are present in the one or more DS 182. Advantageously, PML 304A may be capable of providing significantly improved search performance in this embodiment compared to general purpose processors, while being implementable at a significantly lower cost and with significantly reduced size compared to conventional reduced instruction set and/or content addressable memory based search technologies.

Although not shown in the Figures, additional possible implementation details concerning the PML 304A in an embodiment are described below. It should be understood that many variations, modifications, and alternatives are possible without departing from this embodiment.

PML 304A may include an arithmetic operations unit that may provide arithmetic operations under instruction control to check various conditions. In this embodiment, data source and destination for these operations may be any of 16 sources/destinations. PML 304A may include an arithmetic logic unit (ALU).

Arithmetic operations may be performed in two 32-bit registers (REGA and REGB). After being processed by the ALU, the results may be loaded into a desired result register. The following source encodings (see Table 1 below) may be used for Source#1 and Source#2 in such operations:

TABLE 1

| Source Name | Encoding |
|---|---|
| Value | 0 |
| Counter1 | 1 |
| Countcr2 | 2 |
| Counter3 | 3 |
| PC | 4 |
| DP | 5 |
| Flag Reg | 6 |
| Pattern | Start Position Reg 7 |
| Others | 8-15 |

Advantageously, the set of instructions for PML 304A may permit complex pattern searches to be performed in a very small area, and may execute most pattern matches quickly but without consuming as many resources as a general purpose controller may consume. Possible instructions in such an instruction set may include the following; however, this is only an example and many variations are possible without departing from this embodiment.

### 1.1.1 Load/Store

ALU operations may be a minimum of 2 Bytes long (one byte instruction and one byte opcode) but may be larger depending upon the size of opcodes.

### 1.1.1.1 ALU [Load, Source#1, Source#2]

Source#1 may be one of the provided registers. Source#2 may be a register or on-chip memory location.

### 1.1.1.2 ALU[Store, Source#1, Source#2]

Source#1 may be one of the provided registers. Source#2 may be a register or on-chip memory location. If immediate value is to be written to Source#2, it may be first copied to one of the provided registers before being written to Source#2.

1.1.2 Manipulate Source#1 with Value from Source#2 or Value Directly Supplied in Instruction

Flags affected by these operations are Z, +ve and −ve. The following are different operations that may be performed on Source#1 and Source#2.

### 1.1.2.1 ALU [Cmp, Source#1, Source#2]

This is similar to Sub operation except that Source#1 is not modified. Only flags Z, +ve and −ve may be affected by this operation.

### 1.1.2.2 ALU[Add, Source#1, Source#2]

This adds a value in Source#1 to a value in Source#2. The result is stored in Source#1. Z, +ve and −ve flags are modified.

### 1.1.2.3 ALU [Sub Source#1, Source#2]

This subtracts a value in Source#2 from a value in Source#1. The result is stored in Source#1. Z, +ve and −ve flags are modified.

### 1.1.2.4 ALU [AND, Source#1, Value]

This performs logical AND of a value in Source#1 with a value in Source#2. Z flag is modified.

### 1.1.2.5 ALU [XOR, Source#1, Value]

This performs a logical XOR of a value in Source#1 with a value in Source#2. Z flag is modified.

### 1.1.2.6 ALU[Decr, Source#1]

This decrements the Source#1 value in place. Z flag is modified.

### 1.1.2.7 ALU[Incr, Source#1]

This increments Source#1 value in place. Z flag is modified.

### 1.2 Flags

### 1.2.1 Control Flags

### 1.2.1.1 Set Reset Case Sensitivity

Case sensitivity of input data stream may be set/reset when needed. By default input data stream may be case sensitive. When case insensitivity is set, all input data bytes may be converted to single case (lower case) before being checked.

### Set_Control_Flag[Case_Sensitive, Value]; 0=Case_Sensitive, 1=Case_Insensitive

### 1.2.1.2 Start_Sequence_Check or Start_Multi Byte Check

Start_multi Byte and Range Check (Flags identified by respective checks are set). Set_Control_Flag[Sequence/Multi-Byte, Value]; 1=Sequence Check, 0=Multi-Byte Check
1.2.1.3 Counter 1 and 2 are used as 16-bit counter (saturates at 0 or FFFF hex)

In this case, it is just called counter 1, and counter 2 may be unavailable. Set_Control_Flag[Counter_Size, 8/16 bit]; 1=16-bit, 0=8-bit

### 1.2.2 Status Flags

The hardware may maintain 8 flags (1 bit Boolean values) in a Flag_register and these flags may be used to track when certain operations have happened. These are called Status Flags. The flags may be used in following transitions to either move forward or change pattern execution path.

Flag 0 may be set when current byte matches the desired byte or the Character Class.

Flag 2, 3, 4 may show the result of compare operation (−ve, +ve, Z).

Flag 5 may be set when ever Membership_Check is returned.

Flags 6, 7, 8 may be used by instructions that want explicit flags set.

### 1.3 Matches

1.3.1 Load_CClass # of_Bytes Byte1, Byte2, . . . , Byte 24
Load_CClass[#of_Bytes, Flag_Affected, Byte1, Byte2, . . . , Byte24]

This instruction may load the defined character class. Lists of single bytes may be stored as High-Low. Character classes (stored as pairs representing bottom and top of range) may be stored Low-High so that hardware may easily differentiate which one is matching single bytes and which one matches a character class.

### 1.3.2 Load_Sequence #Bytes Byte1, Byte2, . . . Byte24

Load_Sequence[#of_Bytes, Flag_Affected, Byte1, Byte2, . . . , Byte24]

The sequence vs. character class may be differentiated based on flag setting of “Start_Sequence_Check or Start_Multi Byte Check”. While loading, the load instruction may instruct the hardware as to whether the sequence is being loaded or character class is being loaded.

### 1.3.3 Check_Cx Flag1, Flag2

This may keep checking Flag1 and Flag2 until one of them is set. When one of them is set, the next instruction is executed.

### 1.4 Jumps

In jump instructions, a byte may be consumed when the jump is taken.

### 1.4.1 Jump Byte, Address

This may jump to Address if the input byte matches the instruction Byte.

1.4.2 Jump ̂Byte, Address

This may jump to Address if the input byte does not match the instruction Byte.

### 1.4.3 Jump [0-9A-F], Address: Executed as Jump Flag[1-8], Address

This may jump to Address if the input data byte matches the defined character class. The character class may be first loaded and then the input data byte may be checked.

1.4.4
Jump [̂0-9A-F], Address]: Executed as Jump Flag[1-8], Address

This may jump to Address if the input data byte does not match the defined character class. The character class first may be loaded and then the input data byte may be checked.

### 1.4.5 Jump., Address

This may jump to Address if the input byte is anything but a space character. It is may be executed as a character class match.

### 1.4.6 Jump Address

This may unconditionally jump to Address. No byte may be consumed.

### 1.4.7 Consume #Bytes

This may moves the input data pointer forward by #bytes. No check may be performed on the input data during the move.

### 1.4.8 Move #Bytes

This may moves the input data pointer forward by #bytes. Checks may be performed on the input data during move.

### 1.4.9 Decrement Count# and Jump to Jump_Address if Count !=0

This may be performed by using following sequence:

### ALU[Decr, Counter#]

JUMP[Z=0, Jump_Address]; Z flag may be set when defined counter is zero.

### 1.4.10 Decrement Count# and Jump to Jump_Address if Count=0

This may be performed by using following sequence:

### ALU[Decr, Counter#]

JUMP[Z=1, Jump_Address]; Z flag may be set when defined counter is zero.

### 1.5 Other Flow Control

### 1.5.1 Quit

### Die[Unconditional]; Die Unconditionally

Die[Z=0]; Die if Z flag is zero
Die[+ve]; Die if +ve flag is set
Die[−ve]; Die if −ve flag is set.

### 1.5.2 Fork

This may create a instruction and may pass a jump address and input data pointer to the new instruction. The fork may supply a new program counter (PC) value for the forked thread. The fork may also change the data pointer (DP). If it does not, the current DP may be copied to the forked job.

### Fork [Forked_Instruction_Pointer, Forked_DP]

### 1.5.3 Output Pattern_Id

This may output other pattern related parameters to the output FIFO. The pattern id may be specified by the output instruction. The pattern start pointer may be optionally specified. If it is omitted, the pattern start position register is used. The pattern length may be optionally specified. If it is omitted, the current length (end-start position) is used.

### Output [Pattern_Id[, Pattern_Start_Pointer, Pattern_Length]

### 1.6 Position Register Manipulation

### 1.6.1 Move PC→SPC

This may store the current PC to the SPC register which is useful while executing “.*” instructions. If execution of “.*” fails, execution may resume by skipping just one byte from SDP.

Executed with Load instruction.

### 1.6.2 Move DP→SDP

This may store the current DP to the SDP register which is useful while executing “.*” instructions. If execution of “.*” fails, execution may resume by skipping just one byte from SDP.

Executed with Load instruction

### 1.6.3 Compare Position Register to Fixed Offset

This may check if the current matching byte is within defined offset from the beginning of payload or not.

Executed with ALU[Cmp, . . . ] instruction

### 1.6.4 Set Direction

This may set the direction of execution to backward or forward. When it is set to backward, input data may move backward. It is useful when a fixed string checked by PMC 202 is not at the beginning of pattern but rather is in the middle. PML 304A moves backward once the fixed part in the middle of pattern has been matched.

### 1.7 Membership Checks

1.7.1 Test if Group is being Matched

### ALU[CMP, Curr_Group, Value]

### Jump[Z=0, Address]

### 1.7.2 Test if Matched Pattern is Part of Group Set Defined

### MC[Group_Id, PatternID/GroupID=0]

### Wait[Flag#5]

### ALU[Cmp, REGA, 0]

### Die[Z=0]

### Output[Pattern_Id, Pattern_Start_Pointer, Pattern_Length, Group_Id]

### 1.7.3 Check of First and Only Match for a Pattern or Group

Return Value may be placed in REGA. It is a multi-cycle operation. When results are returned, Flag 5 may be set, and the instruction may wait for Flag 5 after issuing Test-And_Set command. When Flag 5 is set, the instruction may check if it is the first one by determining if the returned bit as “0”. If returned bit is zero, it is a valid pattern. The instruction outputs the matched pattern using Output command. MC[Test_And_Set, Pattern_Id, Base_Address_Identifier, PatternID/GroupID=1]

### Wait[Flag#5]

### ALU[Cmp, REGA, 0]

### Die[Z=0]

### Output[Pattern_Id, Pattern_Start_Pointer, Pattern_Length, Group_Id]

### 1.7.4 Test-and-Set Group_Id_Pattern_Found

This instruction sequence checks if matched pattern is the first in a group defined by Group_Id. The return value is placed in REGA. It is a multi-cycle operation. When results are returned, Flag 5 is set, and the instruction may waits for Flag 5 after issuing Test-And_Set command. When Flag 5 is set, the instruction checks if it is the first by determining if the returned bit is “0”. If returned bit is zero, it is a valid pattern. The instruction outputs the matched pattern using Output command.

### MC[Test_And_Set, Group_Id, Base_Address_Identifier, PatternID/GroupID=1]

### Wait[Flag#5]

### ALU[Cmp, REGA, 0]

### Die[Z=0]

### Output[Pattern_Id, Pattern_Start_Pointer, Pattern_Length, Group_Id]

### 1.7.5 Just-Incr Group-Id Pattern Counter

### MC[Test_And_Incr, Group_Id, Base_Address_Identifier, PatternID/GroupID=1]

### Wait[Flag#5]

### ALU[Cmp, REGA, Value]

Die[+ve]; Die if defined number of patterns have been found in a group.

### Output[Pattern_Id, Pattern_Start_Pointer, Pattern_Length, Group_Id]

### 1.7.6 Test-And-Set Pattern_Id_Pattern_Found

This instruction may check if a given group has already found one valid pattern or not. If such a pattern has already been found, then this new pattern may not be useful. Therefore, the result may be Die, or otherwise output the matched pattern. No more patterns from this group may be output, as one such pattern has already been seen from this group.

### MC [Test-And-Set, Group_Id, Pattern_id_Pattern_Found]

### 1.7.7 Set-Pattern-Disable Pattern_Id

This disables the pattern from PMC 202 that has already been found by PMC 304A and verified.

### MC [Disable_Pattern_Bushy, Pattern_Id]

The foregoing instructions and related information are merely exemplary and many variations are possible without departing from this embodiment. Accordingly, this embodiment should be viewed broadly as encompassing all such alternatives, variations, and modifications as are within the purview of those skilled in the art.

Thus, an embodiment may include circuitry that may determine, at least in part, based at least in part upon history information, whether one or more reference patterns are present in a data stream in a packet flow. The data stream may span at least one packet boundary in the packet flow. The history information may include a beginning portion of a packet in the data stream, an ending portion of the packet, and another portion of the data stream. The circuitry may overwrite the another portion of the history information with a respective portion of the data stream to be examined by the circuitry depending, at least in part, upon whether the circuitry determines, at least in part, whether the one or more reference patterns are present in the data stream. The respective portion may be relatively closer than the another portion is to a beginning of the data stream.

Thus, in this embodiment, examination of the data in the data stream may be carried out substantially entirely or entirely by hardware. Advantageously, this hardware may exhibit improved and/or hardened resistance to tampering by malicious programs compared to conventional software agents. Further advantageously, by using the hardware of this embodiment to perform such examination, the amount of host processor processing bandwidth and the amount of processing time consumed in carrying out such examination may be substantially reduced compared to conventional arrangements in which such software agents are employed for such examination. Also, advantageously, the features and operations of this embodiment that are associated with, for example, use of history information (and particularly backward history information) may make it much easier, compared to such conventional techniques, to compare data from multiple packets (e.g., spanning one or more boundaries between or among the packets), as a combined single unit, to the patterns.

Many variations, alternatives, and modifications are possible without departing from this embodiment. The accompanying claims are intended to encompass all such variations, alternatives, and modifications.

What is claimed is:

1. An apparatus comprising:
circuitry to determine, at least in part, based at least in part upon history information, whether one or more reference patterns are present in a data stream in a packet flow, the data stream spanning at least one packet boundary in the packet flow, the history information including a beginning portion of a packet in the data stream, an ending portion of the packet, and another portion of the data stream, the circuitry to overwrite the another portion of the history information with a respective portion of the data stream to be examined by the circuitry depending, at least in part, upon whether the circuitry determines, at least in part, whether the one or more reference patterns are present in the data stream, the respective portion being relatively closer than the another portion is to a beginning of the data stream.

2. The apparatus of claim 1, wherein:
the history information also includes:
one or more pointers to one or more beginning of line characters in the data stream;
one or more flags to indicate whether one or more other patterns are present in the data stream, the circuitry to indicate a pattern match if both the one or more reference patterns and the one or more other patterns are present in the data stream, regardless of relative displacement between the one or more reference patterns and the one or more other patterns; and
one or more other flags to indicate whether one or more additional patterns have already been found in the data stream, the circuitry not to search again for the one or more additional patterns if the one or more other flags are set.

3. The apparatus of claim 1, wherein:
the circuitry comprises first pattern matching circuitry coupled to second pattern matching circuitry, the first pattern matching circuitry being to determine, based at least in part upon one or more hashing and predetermined pattern matching operations, whether a portion of the one or more reference patterns is present in the data stream, and if the first pattern matching circuitry determines that the portion of the one or more reference patterns is present in the data stream, the second pattern matching circuitry is to determine, based at least in part upon one or more multithreaded pattern matching operations, whether another portion of the one or more reference patterns is present in the data stream;
the one or more hashing and predetermined pattern matching operations are based, at least in part, upon respective tuples comprising respective possible data stream byte patterns and respective hash values; and
the first pattern matching circuitry is to access first memory and second memory, the first memory being to store a database of the respective tuples, the second memory being to store additional tuples as updates to the database.

4. The apparatus of claim 3, wherein:
the first memory also is to store, while also maintaining storage of the database, another version of the database;
each database includes respective instructions to be executed by the second pattern matching circuitry; and
prior to executing a respective instruction from a respective database, the second pattern matching circuitry verifies validity of the respective database.

5. The apparatus of claim 4, wherein:
after storing of the another version of the database, the first pattern matching circuitry is also to discard current results of the one or more hashing operations and to restart the one or more hashing and predetermined pattern matching operations based at least in part upon the another version of the database.

6. The apparatus of claim 1, wherein:
the circuitry determines, at least in part, whether the one or more reference patterns are present in the data stream, based at least in part upon whether one or more classes of characters are present in the data stream.

7. The apparatus of claim 6, wherein:
the circuitry determines, at least in part, whether the one or more reference patterns are present in the data stream, based at least in part upon whether (1) the one or more classes of characters are repeated a predetermined number of times in the data stream and (2) one or more predetermined byte patterns are present in the data stream.

8. The apparatus of claim 1, wherein:
the circuitry is comprised, at least in part, in a circuit card that is to be coupled to a circuit board.

9. A method comprising:
determining, at least in part, by circuitry, based at least in part upon history information, whether one or more reference patterns are present in a data stream in a packet flow, the data stream spanning at least one packet boundary in the packet flow, the history information including a beginning portion of a packet in the data stream, an ending portion of the packet, and another portion of the data stream, the circuitry to overwrite the another portion of the history information with a respective portion of the data stream to be examined by the circuitry depending, at least in part, upon whether the circuitry determines, at least in part, whether the one or more reference patterns are present in the data stream, the respective portion being relatively closer than the another portion is to a beginning of the data stream.

10. The method of claim 9, wherein:
the history information also includes:
one or more pointers to one or more beginning of line characters in the data stream;
one or more flags to indicate whether one or more other patterns are present in the data stream, the circuitry to indicate a pattern match if both the one or more reference patterns and the one or more other patterns are present in the data stream, regardless of relative displacement between the one or more reference patterns and the one or more other patterns; and
one or more other flags to indicate whether one or more additional patterns have already been found in the data stream, the circuitry not to search again for the one or more additional patterns if the one or more other flags are set.

11. The method of claim 9, wherein:
the circuitry comprises first pattern matching circuitry coupled to second pattern matching circuitry, the first pattern matching circuitry being to determine, based at least in part upon one or more hashing and predetermined pattern matching operations, whether a portion of the one or more reference patterns is present in the data stream, and if the first pattern matching circuitry determines that the portion of the one or more reference patterns is present in the data stream, the second pattern matching circuitry is to determine, based at least in part upon one or more multithreaded pattern matching operations, whether another portion of the one or more reference patterns is present in the data stream;
the one or more hashing and predetermined pattern matching operations are based, at least in part, upon respective tuples comprising respective possible data stream byte patterns and respective hash values; and
the first pattern matching circuitry is to access first memory and second memory, the first memory being to store a database of the respective tuples, the second memory being to store additional tuples as updates to the database.

12. The method of claim 11, further comprising:
storing in the first memory, while also maintaining storage of the database, another version of the database;
each database includes respective instructions to be executed by the second pattern matching circuitry; and
prior to executing a respective instruction from a respective database, verifying validity of the respective database by the second pattern matching circuitry.

13. The method of claim 12, wherein:
after storing of the another version of the database, the first pattern matching circuitry is also to discard current results of the one or more hashing operations and to restart the one or more hashing and predetermined pattern matching operations based at least in part upon the another version of the database.

14. The method of claim 9, wherein:
the circuitry determines, at least in part, whether the one or more reference patterns are present in the data stream, based at least in part upon whether one or more classes of characters are present in the data stream.

15. The method of claim 14, wherein:
the circuitry determines, at least in part, whether the one or more reference patterns are present in the data stream, based at least in part upon whether (1) the one or more classes of characters are repeated a predetermined number of times in the data stream and (2) one or more predetermined byte patterns are present in the data stream.

16. The method of claim 9, wherein:
the circuitry is comprised, at least in part, in a circuit card that is to be coupled to a circuit board.

17. Computer-readable memory storing one or more instructions that when executed by a machine result in performance of operations comprising:
determining, at least in part, by circuitry, based at least in part upon history information, whether one or more reference patterns are present in a data stream in a packet flow, the data stream spanning at least one packet boundary in the packet flow, the history information including a beginning portion of a packet in the data stream, an ending portion of the packet, and another portion of the data stream, the circuitry to overwrite the another portion of the history information with a respective portion of the data stream to be examined by the circuitry depending, at least in part, upon whether the circuitry determines, at least in part, whether the one or more reference patterns are present in the data stream, the respective portion being relatively closer than the another portion is to a beginning of the data stream.

18. The computer-readable memory of claim 17, wherein:
the history information also includes:
one or more pointers to one or more beginning of line characters in the data stream;
one or more flags to indicate whether one or more other patterns are present in the data stream, the circuitry to indicate a pattern match if both the one or more reference patterns and the one or more other patterns are present in the data stream, regardless of relative displacement between the one or more reference patterns and the one or more other patterns; and
one or more other flags to indicate whether one or more additional patterns have already been found in the data stream, the circuitry not to search again for the one or more additional patterns if the one or more other flags are set.

19. The computer-readable memory of claim 17, wherein:
the circuitry comprises first pattern matching circuitry coupled to second pattern matching circuitry, the first pattern matching circuitry being to determine, based at least in part upon one or more hashing and predetermined pattern matching operations, whether a portion of the one or more reference patterns is present in the data stream, and if the first pattern matching circuitry determines that the portion of the one or more reference patterns is present in the data stream, the second pattern matching circuitry is to determine, based at least in part upon one or more multithreaded pattern matching operations, whether another portion of the one or more reference patterns is present in the data stream;
the one or more hashing and predetermined pattern matching operations are based, at least in part, upon respective tuples comprising respective possible data stream byte patterns and respective hash values; and
the first pattern matching circuitry is to access first memory and second memory, the first memory being to store a database of the respective tuples, the second memory being to store additional tuples as updates to the database.

20. The computer-readable memory of claim 19, wherein the operations also comprise:
storing in the first memory, while also maintaining storage of the database, another version of the database;
each database includes respective instructions to be executed by the second pattern matching circuitry; and
prior to executing a respective instruction from a respective database, verifying validity of the respective database by the second pattern matching circuitry.

21. The computer-readable memory of claim 20, wherein:
after storing of the another version of the database, the first pattern matching circuitry is also to discard current results of the one or more hashing operations and to restart the one or more hashing and predetermined pattern matching operations based at least in part upon the another version of the database.

22. The computer-readable memory of claim 17, wherein:
the circuitry determines, at least in part, whether the one or more reference patterns are present in the data stream, based at least in part upon whether one or more classes of characters are present in the data stream.

23. The computer-readable memory of claim 22, wherein:
the circuitry determines, at least in part, whether the one or more reference patterns are present in the data stream, based at least in part upon whether (1) the one or more classes of characters are repeated a predetermined number of times in the data stream and (2) one or more predetermined byte patterns are present in the data stream.

24. The computer-readable memory of claim 23, wherein:
the circuitry is comprised, at least in part, in a circuit card that is to be coupled to a circuit board.
